(19) United States
(12) Patent Application Publication
(10) Pub. No.: US 2025/0308420 A1
(43) Pub. Date: Oct. 2, 2025

(54) TO-BE-CUT DISPLAY PANEL, CHIP ON FILM, DISPLAY PANEL, AND DISPLAY APPARATUS

(71) Applicants: Wuhan Tianma Microelectronics Co., Ltd., Wuhan (CN); Wuhan Tianma Microelectronics Co., Ltd. Shanghai Branch, Shanghai (CN)

(72) Inventors: Zhuan GAO, Wuhan (CN); Peng ZHANG, Wuhan (CN)

(21) Appl. No.: 19/192,314

(22) Filed: Apr. 28, 2025

(30) Foreign Application Priority Data
May 17, 2024 (CN) 202410623207.8

(51) Int. Cl. G09G 3/00

(52) U.S. Cl. CPC G09G 3/006; G09G 2330/12

(57) ABSTRACT

A to-be-cut display panel, a chip on film (COF), a display panel, and a display apparatus. The to-be-cut display panel includes a non-display region and a display region including sub-pixels. The non-display region includes: a drive pad electrically connected to the sub-pixel; a test pad configured to receive a test signal and electrically connected to the drive pad; and a connection pad between the drive pad and the test pad and configured to electrically connect the drive pad and the test pad. The connection pad includes first portions and second portions that are arranged alternately along an extension direction of the connection pad. A Cross-sectional area of the first portion is less than that of the second portion in the direction perpendicular to the extension direction of the connection pad, and/or a melting point of the first portion is lower than that of the second portion.

### CROSS-REFERENCE TO RELATED APPLICATIONS

The present application claims priority to Chinese patent application No. 202410623207.8, filed on May 17, 2024, which is hereby incorporated by reference in its entirety.

### TECHNICAL FIELD

The present disclosure relates to the field of display technologies, and in particular, to a to-be-cut display panel, a chip on film (COF), a display panel, and a display apparatus.

### BACKGROUND

With the continuous development of science and technology, more and more electronic devices with a display function are widely used in people's daily life and work, thereby providing great convenience to people's daily life and work, and nowadays are becoming indispensable and important tool for people. A main component for the electronic device to achieve the display function is a display panel.

A visual test (VT) for display panel is an important part of the manufacturing process of the display panel. The VT is refers to that: after the display panel is manufactured, various signal lines including a data line and a scanning line in the display panel are connected to the corresponding test pads. Corresponding test signals are loaded onto the test pads on the display panel through a test apparatus, such that the display panel displays an image to check whether the structures including the signal lines in the display panel meet the quality requirements. The VT can prevent a defective product from entering a subsequent module stage.

After the VT, the test pads need to be removed. At present, when removing the test pads, the cutting yield is relatively low, so that it is prone to resulting in a short circuit between two adjacent pads.

### SUMMARY

In view of this, the present disclosure provides a to-be-cut display panel, a COF, a display panel, and a display apparatus, in order to improve the cutting yield of the display panel.

According to a first aspect, an embodiment of the present disclosure provides a to-be-cut display panel including a non-display region and a display region. The display region includes sub-pixels. The non-display region includes: a drive pad electrically connected to the sub-pixels; a test pad configured to receive a test signal and electrically connected to the drive pad; and a connection pad provided between the drive pad and the test pad and configured to electrically connect the drive pad and the test pad.

The connection pad includes a plurality of first portions and second portions that are arranged alternately along an extension direction of the connection pad.

A cross-sectional area of at least one of the first portions in a direction perpendicular to the extension direction of the connection pad is less than a cross-sectional area of at least one of the second portions in the direction perpendicular to the extension direction of the connection pad, and/or a melting point of the first portion is lower than a melting point of the second portion.

According to a second aspect, an embodiment of the present disclosure provides a COF including a plurality of pins. At least one of the plurality of pins includes a third portion and a fourth portion. A width of the third portion is less than a width of the fourth portion, width directions of the third portion and the fourth portion are perpendicular to an extension direction of the pins, and the third portion is adjacent to an edge of the COF.

According to a third aspect, an embodiment of the present disclosure provides a display panel. The display panel is formed by cutting the foregoing to-be-cut display panel. A cutting line passes through the connection pad.

According to a fourth aspect, an embodiment of the present disclosure provides a display apparatus including the foregoing COF and the foregoing display panel. At least one of the pins in the COF and at least one drive pad are electrically connected to each other in one-to-one correspondence.

In the to-be-cut display panel, the COF, the display panel, and the display apparatus according to the embodiments of the present disclosure, the connection pad includes the first portion and the second portion. The cross-sectional area of at least one of the first portions in the direction perpendicular to the extension direction of the connection pad is less than the cross-sectional area of at least one of the second portions in the direction perpendicular to the extension direction of the connection pad. When cutting the to-be-cut display panel, the first portion is prone to be fractured, and the lengths of the metal fragments formed after the first portion is fractured are controllable. As a result, the metal fragments can be prevented from lapping over two adjacent drive pads, thereby reducing a probability of a short circuit between the two adjacent drive pads and improving the yield and reliability of the product.

### BRIEF DESCRIPTION OF DRAWINGS

In order to illustrate the technical solutions in the embodiments of the present disclosure more clearly, the accompanying drawings required for describing the embodiments will be briefly introduced. Apparently, the accompanying drawings in the following description merely show some embodiments of the present disclosure, and a person of ordinary skill in the art may also derive other accompanying drawings from these accompanying drawings without any creative effort.

FIG. 1 is a schematic diagram showing that two adjacent drive pads are short-circuited by a metal fragment in the related art;

FIG. 2 is a schematic diagram of a to-be-cut display panel according to an embodiment of the present disclosure;

FIG. 3 is a schematic diagram of another to-be-cut display panel according to an embodiment of the present disclosure;

FIG. 4 is a schematic diagram showing a critical state when a COF and a drive pad that are bonded to each other are short-circuited by a second portion according to an embodiment of the present disclosure;

FIG. 5 is another schematic diagram showing at least one drive pad, at least one connection pad, and at least one test pad according to an embodiment of the present disclosure;

FIG. 6 is still another schematic diagram showing at least one drive pad, at least one connection pad, and at least one test pad according to an embodiment of the present disclosure;

FIG. 7 is a schematic diagram of a COF according to an embodiment of the present disclosure;

FIG. 8 is a schematic diagram of another COF according to an embodiment of the present disclosure;

FIG. 9 is a schematic diagram of a display panel according to an embodiment of the present disclosure;

FIG. 10 is a schematic top view of a display apparatus according to an embodiment of the present disclosure; and

FIG. 11 is a schematic cross-sectional view of a display apparatus according to an embodiment of the present disclosure.

### DETAILED DESCRIPTION OF THE EMBODIMENTS

In order to understand of the technical solutions of the present disclosure better, the embodiments of the present disclosure are described in detail below with reference to the accompanying drawings.

It should be noted that the embodiments in the following descriptions are merely parts of rather than all of the embodiments of the present disclosure. All other embodiments obtained by a person of ordinary skill in the art on the basis of the embodiments of the present disclosure without any creative effort shall fall within the protection scope of the present disclosure.

Terms used in the embodiments of the present disclosure are just for the purpose of describing specific embodiments, but not intended to limit the present disclosure. Unless otherwise specified in the context, the terms such as “a”, “the”, and “said”, in a singular form, in the embodiments of the present disclosure and the appended claims also include plural forms.

It should be understood that the term “and/or” in this specification merely describes association relationships between the associated objects, and indicates three types of relationships. For example, “A and/or B” may indicate that A exists alone, A and B coexist, or B exists alone. In addition, the character “/” in the specification generally indicates that the associated former and latter objects are in an “or” relationship.

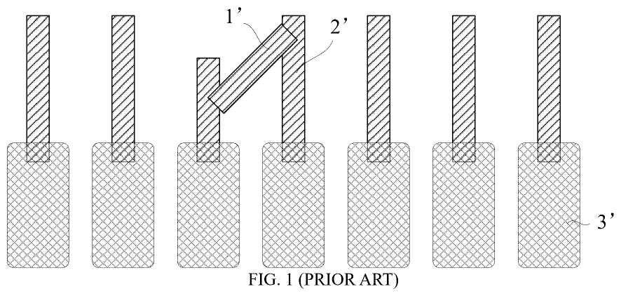

As described in the background section, at present, when removing a test pad, the cutting yield is relatively low, so that it is prone to result in a short circuit between two adjacent pads. In a process of implementing the embodiments of the present disclosure, the inventor has found through research that when a VT is completed and the test pad is cut and removed, a metal film layer excluding a cutting line may be detached caused by the cutting and, and the metal fragments generated by the detachment may lap over the drive pad in the display panel. The metal fragments have random lengths generated by the detachment. Therefore, if the metal fragment is too long, as shown in FIG. 1 which is a schematic diagram showing that two adjacent drive pads are short-circuited by a metal fragment in the related art, a metal fragment l′ generated by the detachment laps over two adjacent connection pads 2′. As a result, two adjacent drive pads 3′ electrically connected to the connection pads 2′ are short-circuited, thereby resulting in poor display.

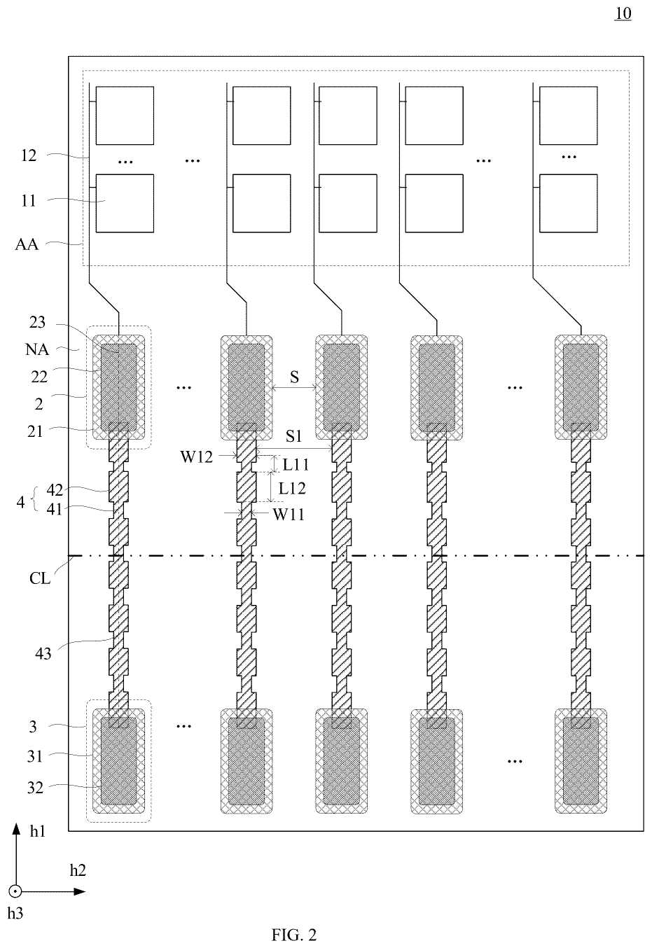

In view of this, an embodiment of the present disclosure provides a to-be-cut display panel. FIG. 2 is a schematic diagram of a to-be display panel 10 according to an embodiment of the present disclosure. As shown in FIG. 2, the to-be-cut display panel 10 includes a non-display region NA and a display region AA. The display region AA includes sub-pixels 11. For example, as shown in FIG. 2, the display region AA further includes a plurality of signal lines 12 electrically connected to the sub-pixels 11. The non-display region NA includes a drive pad 2, a test pad 3, and a connection pad 4.

In an embodiment, the drive pad 2 is electrically connected to the sub-pixels 11. For example, the drive pad 2 is electrically connected to the sub-pixels 11 through the signal line 12. In an embodiment, the drive pad 2 includes at least two stacked metal layers to reduce the resistance of the drive pad 2. In an example, as shown in FIG. 2, the drive pad 2 includes a first driving metal layer 21 and a second driving metal layer 22 that are stacked with each other. In an embodiment, the drive pad 2 is made of materials including metal. For example, the metal includes molybdenum (Mo), copper (Cu), aluminum (Al), silver (Ag), chromium (Cr), tantalum (Ta), titanium (Ti), etc., or a metal alloy formed by a combination of any two or more of the above.

The test pad 3 is configured to receive test signals during a VT. The test pad 3 is electrically connected to the drive pad 2 to transmit the test signal to the sub-pixels 11 in the display region AA through the drive pad 2. In an embodiment, the test pad 3 includes at least two metal layers stacked one after another to reduce resistance of the test pad 3. In an example, as shown in FIG. 2, the test pad 3 includes a first test metal layer 31 and a second test metal layer 32 that are stacked with each other. In an embodiment, the test pad 3 is made of materials including metal. For example, the metal includes molybdenum (Mo), copper (Cu), aluminum (Al), silver (Ag), chromium (Cr), tantalum (Ta), titanium (Ti), etc., or the metal alloy formed by a combination of any two or more of the above. For example, the first test metal layer 31 and the first driving metal layer 21 may be provided in the same layer, and the second test metal layer 32 and the second driving metal layer 22 may be provided in the same layer, too. The wording “provided in the same layer” means that the two are formed in the same patterning process using the same material. The patterning process includes steps such as film formation, exposure, development, and etching.

As shown in FIG. 2, the connection pad 4 is arranged between the drive pad 2 and the test pad 3, and configured to electrically connect the drive pad 2 to the test pad 3. For example, the connection pad 4 may include one or more metal layers. In an example, as shown in FIG. 2, the connection pad 4 includes one metal layer.

In an embodiment of the present disclosure, as shown in FIG. 2, the connection pad 4 includes a plurality of first portions 41 and second portions 42 that are arranged alternately along an extension direction of the connection pad 4. The cross-sectional area of the first portion 41 in a direction perpendicular to the extension direction of the connection pad 4 is less than the cross-sectional area of the second portion 42 in the direction perpendicular to the extension direction of the connection pad 4, and/or a melting point of the first portion 41 is lower than a melting point of the second portion 42. Based on this configuration, when the to-be-cut display panel 10 is cut by laser, the maximum laser energy that the first portions 41 can withstand may be set to be less than the maximum laser energy that the second portions 42 can withstand. In other words, under the same laser energy, the first portions 41 are more prone to be fractured than the second portions 42.

In an implementation, in an embodiment of the present disclosure, a width of the first portion 41 is less than a width of the second portion 42, and/or a thickness of the first portion 41 is less than a thickness of the second portion 42, such that the cross-sectional area of the first portion 41 in the direction perpendicular to the extension direction of the connection pad 4 is less than the cross-sectional area of the second portion 42 in the direction perpendicular to the extension direction of the connection pad 4. As a result, when the display panel is cut by laser, the first portion 41 is more prone to be fractured than the second portion 42. A width direction of the first portion 41 is perpendicular to an extension direction of the first portion 41, and a width direction of the second portion 42 is perpendicular to the extension direction of the first portion 41. In an example, as shown in FIG. 1, the width of the first portion 41 is less than the width of the second portion 42, and both the first portion 41 and the second portion 42 extend along a first direction h1. Both the width direction of the first portions 41 and the width direction of the second portions 42 are parallel to a second direction h2, and the second direction h2 is perpendicular to the first direction h1.

In another implementation, in an embodiment of the present disclosure, the first portions 41 and the second portions 42 may be made of different materials, and the melting point of the first portions 41 is lower than the melting point of the second portions 42.

For example, after the VT is completed, the test pad 3 is removed as a useless pad. When the test pad 3 is removed, as shown in FIG. 2, a cutting line CL can pass through the connection pad 4. For example, the process of removing the test pad 3 includes laser cutting or blade cutting. Based on the above implementation in the embodiments of the present disclosure, when the to-be-cut display panel 10 is cut, the first portions 41 are fractured prior to the second portions 42, and a metal fragment formed after the first portions 41 are fractured is the second portions 42 between two adjacent first portions 41. In an embodiment, the cutting line CL can pass through the first portions 41 or the second portions 42 of the connection pad 4. In an example, as shown in FIG. 2, the cutting line CL passes through the first portion 41.

In an embodiment of the present disclosure, the connection pad 4 includes a plurality of first portions 41 and second portions 42 that are arranged alternately along the extension direction of the connection pad 4. The cross-sectional area of at least one of the first portions 41 in the direction perpendicular to the extension direction is less than the cross-sectional area of at least one of the second portions 42 in the direction perpendicular to the extension direction, and/or the melting point of at least one of the first portions 41 is lower than the melting point of at least one of the second portions 42. In this case, the first portions 41 are more prone to be fractured under the action of the cutting. Compared with the situation that the fracture capacities at different positions of the connection pad 4 are equal to each other and relatively small, in the method according to an embodiment of the present disclosure, the metal fragments, which are formed after the connection pad 4 is fractured caused by cutting, are the second portions 42, so that the lengths of the metal fragments formed by the second portions 42 are controllable. As a result, it is impossible for a second portion 42 to lap over two adjacent drive pads 2 at the same time, the short circuit between two adjacent drive pads 2 can be avoided, and the cutting yield of the to-be-cut display panel 10 can be improved.

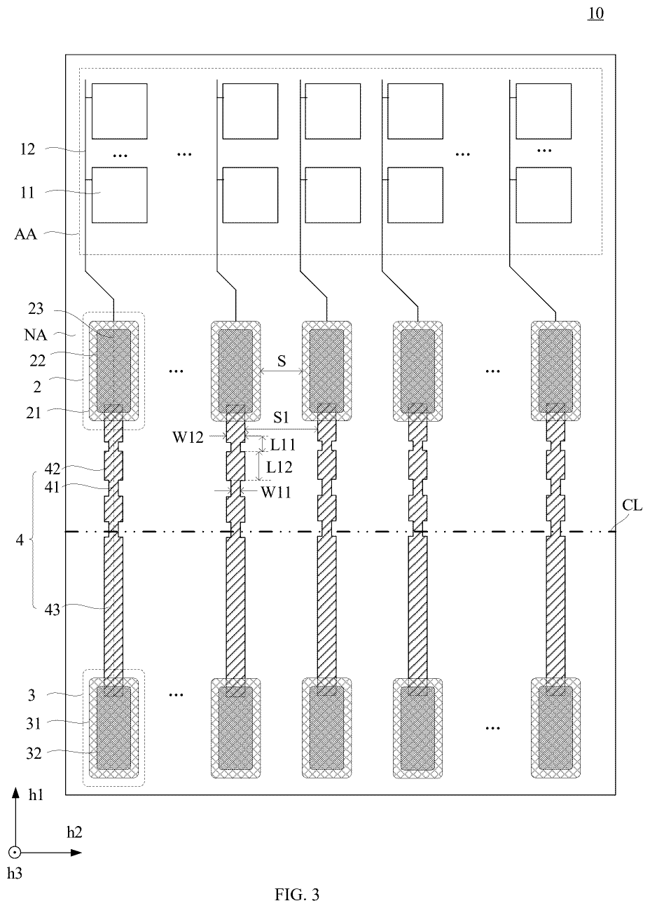

For example, FIG. 3 is a schematic diagram of another to-be-cut display panel according to an embodiment of the present disclosure. As shown in FIG. 3, the connection pad 4 includes an equally wide portion 43 at a side of the cutting line CL away from the drive pad 2. For example, a width of the equally wide portion 43 may be the same as the width of the second portion 42. The equally wide portion 43 is located at the side of the cutting line CL away from the drive pad 2. After the to-be-cut display panel 10 is cut, even if a metal fragment formed by the equally wide portion 43 due to the cutting is long, this portion can be removed together with the test pad 3 without short-circuiting the two adjacent drive pads 2. Therefore, in an embodiment of the present disclosure, the equally wide portion 43 can be set at the side of the cutting line CL away from the drive pad 2, thereby reducing the design difficulty of the connection pad 4 while ensuring the cutting yield of the to-be-cut display panel 10.

For example, as shown in FIG. 2 and FIG. 3, a length L11 of the first portion 41 satisfies: L11≥3 μm, and a length direction of the first portion 41 is parallel to the extension direction of the connection pad 4. In an example, as shown in FIG. 2 and FIG. 3, the connection pad 4 extends along the first direction h1. Based on this configuration, the length of the first portion 41 will be prevented from being configured too small, and the process difficulty in preparing the first portion 41 will be reduced.

In an embodiment, the width W11 of the first portion 41 satisfies: 3 μm≤W11≤5 μm, for example, W11=4 μm. In an embodiment of the present disclosure, the width of the first portion 41 can be prevented from being set too small by setting 3 μm≤W11. In this case, on one hand, the process difficulty in preparing the first portion 41 can be reduced, and on the other hand, when the VT is conducted on the to-be-cut display panel 10, the excessive density of the current flowing through the first portion 41 can be prevented from being too large to affect the VT. In an embodiment of the present disclosure, the cross-sectional area of the first portion 41 in the direction perpendicular to the extension direction of the connection pad 4 may be relatively small by setting W11≤5 μm. Therefore, when the to-be-cut display panel 10 is cut, the first portion 41 is more prone to be fractured.

For example, in an embodiment of the present disclosure, a length L12 of the second portion 42 satisfies: L12<S−X−D1, where S represents a shortest distance between the two adjacent drive pads 2, X represents the accuracy of binding the drive pad 2 and the COF to be bonded to the drive pad 2, and D1 represents a diameter of a conducting particle in an anisotropic conductive film (ACF) used for binding the drive pad 2 and the COF. The conducting particle is configured to electrically connect a pin in the COF to the drive pad 2.

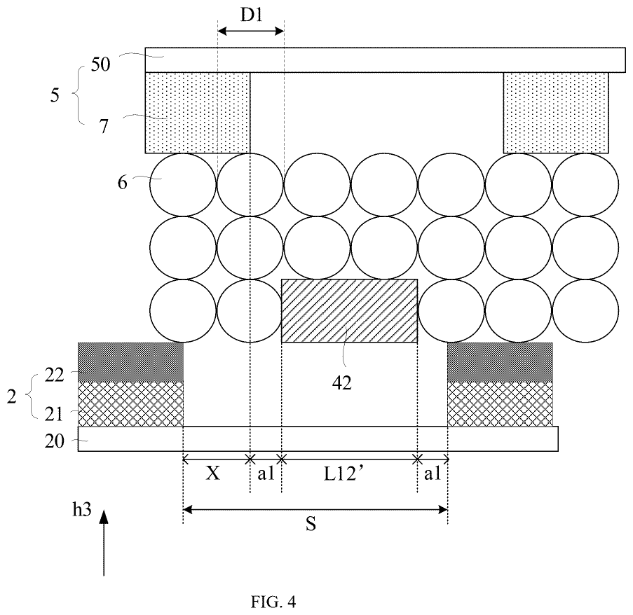

As mentioned above, the to-be-cut display panel 10 will be cut after the VT, and the COF and the drive pad 2 will be connected to each other by binding via the ACF. The conducting particle in the ACF has unidirectional conductivity. In other words, the conducting particle is conductive only in a direction h3 perpendicular to the plane of the to-be-cut display panel 10. Therefore, after the to-be-cut display panel 10 is cut, if the second portion 42 between the two adjacent first portions 41 forms a fractured fragment, and when a short circuit occurs due to an electrical connection between the pin in the COF and the drive pad 2 through the conducting particles and the fractured fragments formed by the second portion 42, there is a positional relationship shown in FIG. 4. FIG. 4 is a schematic diagram showing a critical state when the COF 5 and the drive pad 2 that are connected in the binding mode are short-circuited by the second portion 42. As shown in FIG. 4, the drive pad 2 is formed at a side of a first substrate 20. The drive pad 2 includes a first driving metal layer 21 and a second driving metal layer 22. The pin 7 in the COF 5 is formed at a side of a flexible substrate 50, and 2a1+L12′+X=S, where a1 represents a radius of the conducting particle 6, namely a1=D1/2; and L12′ represents a critical length of the fractured fragment that can short-circuit the two adjacent drive pads 2. It can be inferred that L12′=S−X−D1. Therefore, by setting L12<S−X−D1=L12′, the fractured fragments formed by the second portion 42 can be prevented from being cooperated with the conducting particle 6 to short-circuit the two adjacent drive pads 2, thereby improving the cutting yield of the to-be-cut display panel 10. The accuracy of binding the COF 5 to the drive pad 2 is determined based on the binding device and the process capability.

In an embodiment, in an embodiment of the present disclosure, the width W12 of the second portion 42 satisfies: W12≥5.5 μm. Based on this configuration, on one hand, it can be ensured that the second portion 42 can have a large the cross-sectional area in the direction perpendicular to the extension direction of the connection pad 4, so that the second portion 42 can be prevented from being fractured prior to the first portion 41 during cutting. On the other hand, when the VT is conducted on the to-be-cut display panel 10, a density of the current flowing through the second portion 42 can be reduced, which is conducive to conducting the VT.

For example, as shown in FIG. 2 and FIG. 3, the connection pad 4 and the drive pad 2 electrically connected to the connection pad 4 are arranged along the extension direction of the connection pad 4. In an example, as shown in FIG. 2, the connection pad 4 extends along the first direction h1, and the connection pad 4 and the connected drive pad 2 electrically connected to the connection pad 4 are arranged along the first direction h1. In an embodiment, as shown in FIG. 2 and FIG. 3, within the process error range, an extension line of a first centerline 43 of the connection pad 4 extending along the first direction h1 passes through a second centerline 23 of the drive pad 2 extending along the first direction h1.

In an embodiment of the present disclosure, the shortest distance S1 between two adjacent connection pads 4 is greater than or equal to P1/2, and P1=W12+S1, where W12 represents the width of the second portion 42, and S1 represents the shortest distance between the two adjacent connection pads 4. It can be inferred that S1≥W12. That is, the shortest distance between the two adjacent connection pads 4 is greater than or equal to the width of the second portion 42. Based on this configuration, the shortest distance S1 between the two adjacent connection pads 4 can be increased as much as possible, so as to maximize the shortest distance between the two adjacent drive pads 2 as much as possible. Under the condition that the binding area between the drive pad 2 and the COF is satisfied, a risk of short-circuiting the two adjacent connection pads 4 or drive pads 2 can be reduced. For example, when P1=24 μm, S12≥12 μm can be set in an embodiment of the present disclosure.

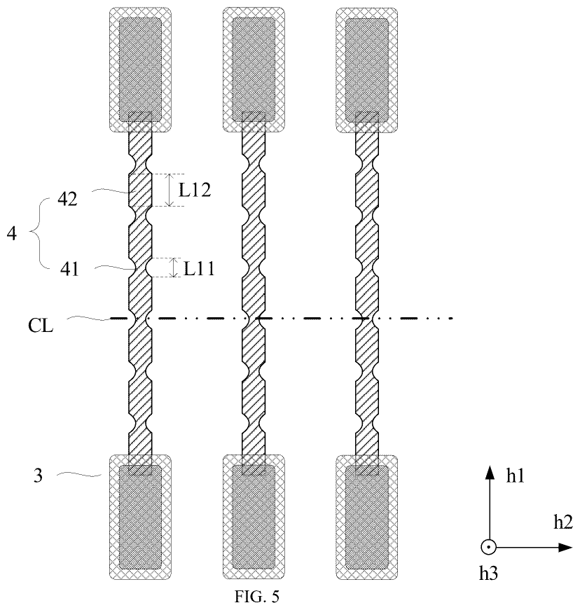

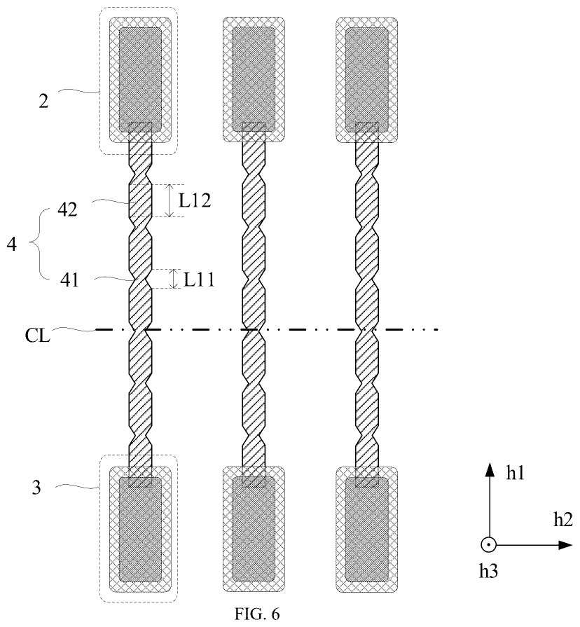

In an embodiment, as shown in FIG. 2 and FIG. 3, in an embodiment of the present disclosure, the first portion 41 may have a same width at different positions. Alternatively, in an embodiment of the present disclosure, the first portion 41 may have different widths at different positions. FIG. 5 and FIG. 6 show two other embodiments of at least one drive pad, at least one connection pad, and at least one test pads according to the present disclosure. As shown in FIG. 5 and FIG. 6, the first portion 41 has a narrow central position and a wide end close to the second portion 42. Along a direction in which the second portion 42 points towards the first portion 41, the width of the first portion 41 gradually decreases. In the implementations illustrated in FIG. 5 and FIG. 6, a width of the first portion 41 at all the positions satisfies: 3 μm≤W11≤5 μm.

For example, as shown in FIG. 2, FIG. 3, and FIG. 6, in an embodiment of the present disclosure, an edge of the first portion 41 has a shape of a straight line. Alternatively, as shown in FIG. 5, in an embodiment of the present disclosure, the edge of the first portion 41 has a shape of an arc.

Based on the same inventive concept, an embodiment of the present disclosure further provides a COF. The COF is a crystal soft film on which a driver chip is fixed in a flexible circuit board. The COF can be configured to connect a display panel and a printed circuit board (PCB) to achieve signal transmission between the PCB and the display panel. The PCB may be a flexible printed circuit (FPC).

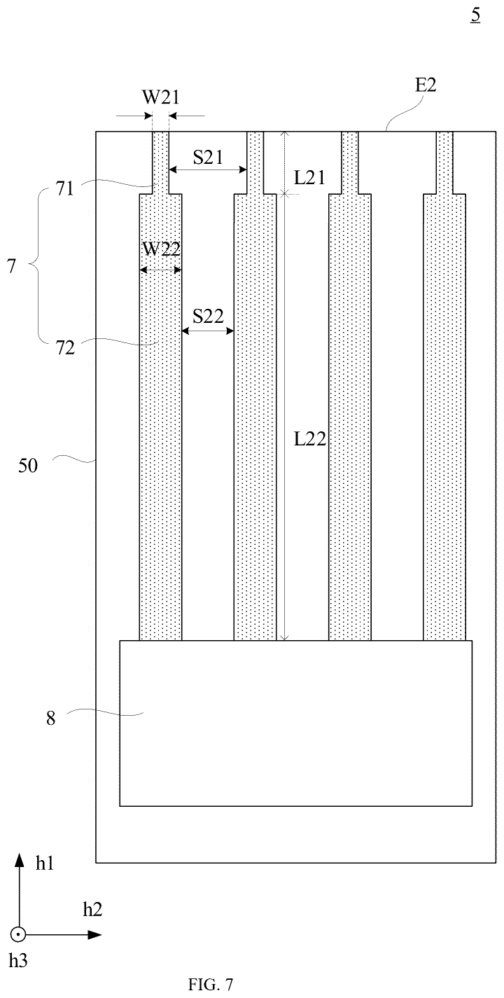

FIG. 7 is a schematic diagram of a COF according to an embodiment of the present disclosure. As shown in FIG. 7, the COF 5 includes a flexible substrate 50, a driver chip 8, and a plurality of pins 7. The driver chip 8 is electrically connected to the pins 7.

In an embodiment of the present disclosure, as shown in FIG. 7, at least one of the pins 7 includes a third portion 71 and a fourth portion 72. A width W21 of the third portion 71 is less than a width W22 of the fourth portion 72, both width directions of the third portion 71 and the fourth portion 72 are perpendicular to an extension direction of the pin 7, and the third portion 71 is adjacent to a second edge E2 of the COF 5. In an example, as shown in FIG. 7, the pin 7 extends along a first direction h1, and both the width directions of the third portion 71 and the fourth portion 72 each are parallel to a second direction h2.

At present, the COF 5 is generally formed in a form of a coiled material. After being prepared, the coil material needs to be cut to form a plurality of independent COFs 5. For example, a cutting process includes punching. During the cutting, a film layer at a side close to a cutting line in a pin 7 is prone to detachment. If a detached fragment laps over two adjacent pins 7, the two pins 7 that should have been insulated would be electrically connected with each other, thereby resulting in a short circuit and abnormal display after energization.

In an embodiment of the present disclosure, when the COF 5 is formed via cutting, the cutting line passes through the third portion 71, and the fourth portion 72 is located within the cutting line. The cutting line is the second edge E2 of the COF 5 formed after the cutting. In an embodiment of the present disclosure, at least one of the pins 7 in the COF 5 includes a third portion 71 and a fourth portion 72 that are arranged along the extension direction of the pin 7. The width of the third portion 71 is less than the width of the fourth portion 72. That is, in an embodiment of the present disclosure, due to a non-equal-width design for the pin 7, even if a film layer in the third portion 71 close to the cutting line is detached and shifted, a possibility of a short circuit caused by lapping over the two adjacent pins 7 can be reduced and the yield and the display effect can be improved, because the width of the third portion 71 is narrow and a distance between two adjacent third portions 71 is large.

For example, as shown in FIG. 7, a shortest distance S21 between the two adjacent third portions 71 satisfies: S21≥(W21+S21)/2, where W21 represents the width of the third portion 71, and S21 represents the shortest distance between the two adjacent third portions 71. The width direction of the third portion 71 is perpendicular to the extension direction of the pin 7. In an example, as shown in FIG. 7, the pin 7 extends along the first direction h1, the width direction of the third portion 71 is parallel to the second direction h2, and the second direction h2 is perpendicular to the first direction h1. Based on this configuration, it can be set that S21≥W21. That is, the shortest distance between the two adjacent third portions 71 is greater than or equal to the width of the third portion 71. In this embodiment of the present disclosure, the shortest distance S21 between the two adjacent third portions 71 are increased to reduce a risk of short-circuiting the two adjacent pins 7 under the condition that the binding area between the pin 7 in the COF 5 and a drive pad 2 is satisfied.

For example, as shown in FIG. 7, the width W22 of the fourth portion 72 is less than or equal to a shortest distance S22 between two adjacent fourth portions 72, and the width direction of the fourth portion 72 is perpendicular to the extension direction of the pin 7. In an example, as shown in FIG. 7, the pin 7 extends along the first direction h1, the width direction of the fourth portion 72 is parallel to the second direction h2, and the second direction h2 is perpendicular to the first direction h1. Based on this configuration, the risk of short-circuiting the two adjacent pins 7 can be further reduced.

In an embodiment, as shown in FIG. 7, a length L21 of the third portion 71 and a length L22 of the fourth portion 72 satisfy: L22/10≤L21≤L22/6, for example, L21=L22/8. If the third portion 71 with a narrow width is set to be too long, after the drive pad 2 and the COF 5 are bound, a current density in the pin 7 will be too large when providing driving signals to the drive pad 2 through the COF 5, which is not conducive to signal transmission. By setting L22/10≤L21≤L22/6, in this embodiment of the present disclosure, normal transmission of signals between the drive pad 2 and the pin 7 can be ensured while reducing the risk of short-circuiting the two adjacent pins 7.

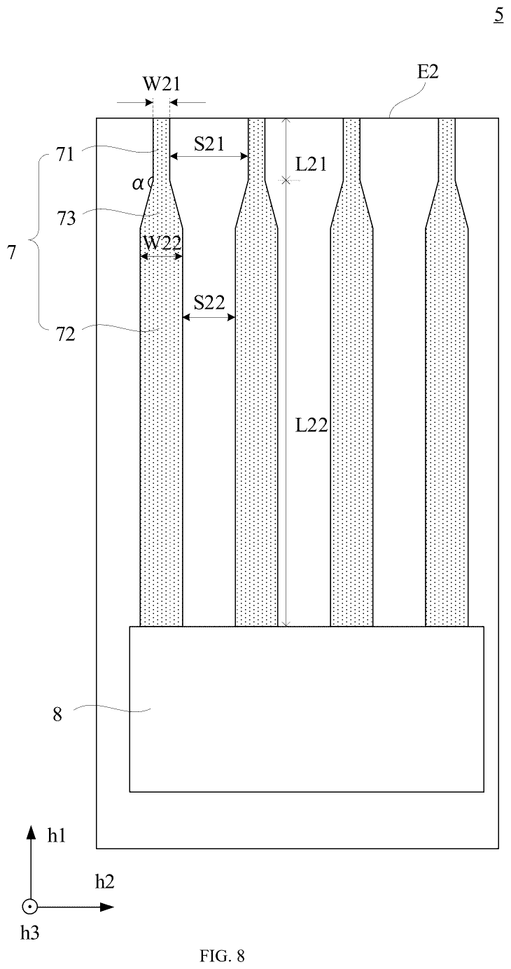

For example, FIG. 8 is a schematic diagram of another COF according to an embodiment of the present disclosure. As shown in FIG. 8, the pin 7 further includes a fifth portion 73 provided between the third portion 71 and the fourth portion 72. An angle α is formed between an edge of the fifth portion 73 and an edge of the third portion 71, and 120°≤α≤150°. In this embodiment of the present disclosure, the fifth portion 73 is provided as a transition portion between the third portion 71 and the fourth portion 72 that have different widths, and 120°≤α≤150°. As a result, a sudden width change can be avoided in the pin 7, and concentrated local stress can be avoided in the pin 7, which is conductive to the preparation of the pin 7.

Based on the same inventive concept, an embodiment of the present disclosure further provide a display panel. For example, when preparing the display panel, a to-be-cut display panel 10 as shown in FIG. 2 is provided first, and then a test signal is provided for the test pad 3 to conduct a lighting test on the sub-pixels in the to-be-cut display panel 10. After the test, the test pad 3 can be removed to obtain the display panel.

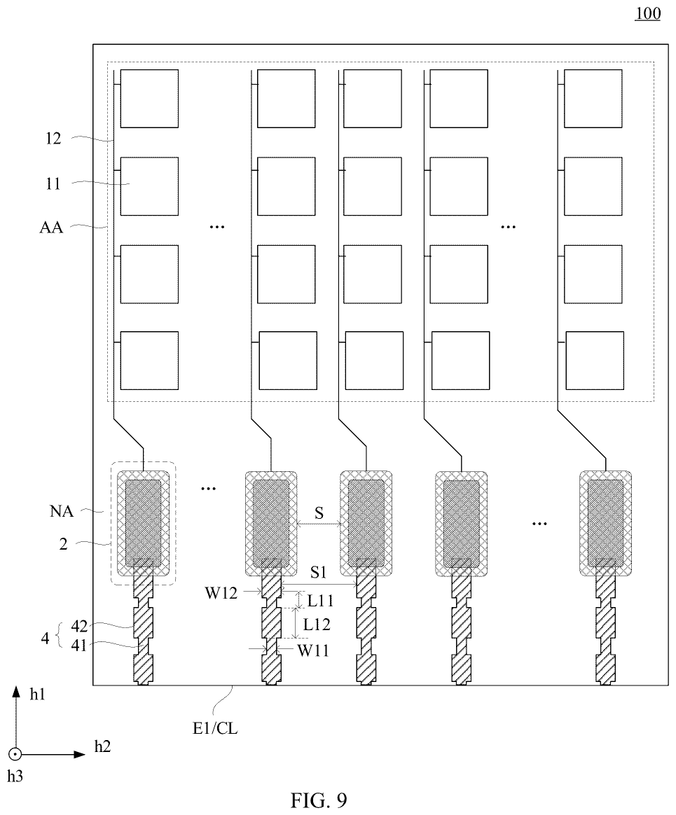

FIG. 9 is a schematic diagram of a display panel 100 according to an embodiment of the present disclosure. As shown in FIG. 9, the display panel 100 is formed by cutting the foregoing to-be-cut display panel 10. In combination with FIG. 2 and FIG. 9, a first edge E1 of the display panel 10 is a cutting line CL when the to-be-cut display panel 10 is cut. As shown in FIG. 9, the first edge E1 of the display panel 10 passes through the connection pad 4. Comparing FIG. 9 with FIG. 1, it can be seen that the display panel 100 does not include a test pad. As a result, the display panel 100 have a non-display region NA with a small area, thereby improving a screen-to-body ratio of the display panel 100.

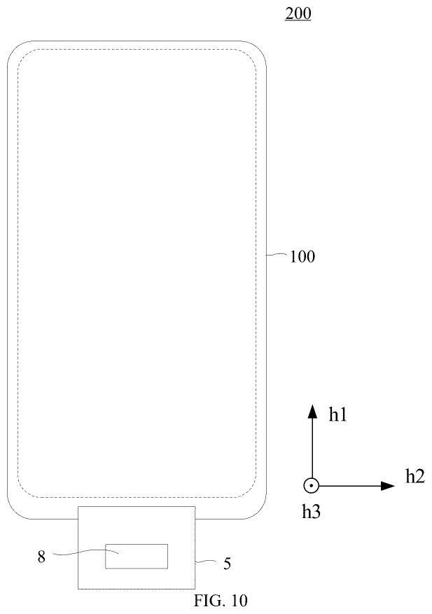

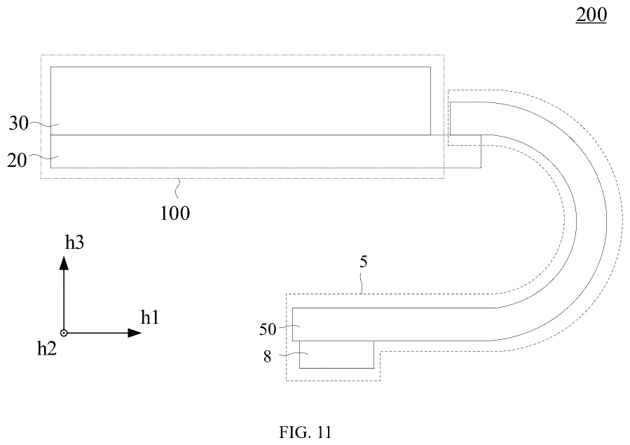

Based on the same inventive concept, an embodiment of the present disclosure further provide a display apparatus. The display apparatus includes the foregoing COF 5 and display panel 10. FIG. 10 is a schematic top view of a display apparatus 200 according to an embodiment of the present disclosure. As shown in FIG. 10, the COF 5 is in an unfolded state. FIG. 11 is a schematic cross-sectional view of the display apparatus 200 according to an embodiment of the present disclosure. The COF 5 is in a bent state. The pins in the COF 5 (not shown in FIG. 10 and FIG. 11) and the drive pads 2 in the display panel 100 are electrically connected to each other in one-to-one correspondence. Specific structures of the display panel 100 and the COF 5 have been described in detail in the foregoing embodiments, which will not be described herein again. It should be noted that the display apparatuses as shown in FIG. 10 and FIG. 11 are just schematic illustration. For example, the display apparatus may be any electronic device with a display function, such as a mobile phone, a tablet computer, a notebook computer, an e-book, or a television.

For example, as shown in FIG. 11, the COF 5 can be bent towards a side away from a light output side of the display panel 100 to reduce a border width of the display apparatus 200 and increase a screen-to-body ratio of the display apparatus 200.

As shown in FIG. 11, the display panel 10 includes a display film layer 30 formed at a side of the first substrate 20. The display film layer 30 is configured to form the foregoing sub-pixels.

The above descriptions are merely preferred embodiments of the present disclosure, and are not intended to limit the present disclosure. Any modifications, equivalent replacements, improvements, and the like made within the spirit and principle of the present disclosure shall fall within the protection scope of the present disclosure.

What is claimed is:

1. A to-be-cut display panel, comprising:
a display region comprising:
sub-pixels; and
a non-display region comprising:
at least one drive pad electrically connected to the sub-pixels;
a test pad configured to receive a test signal and electrically connected to the at least one drive pad; and
a connection pad provided between the at least one drive pad and the test pad and configured to electrically connect the at least one drive pad to the test pad;
wherein the connection pad comprises a plurality of first portions and a plurality of second portions arranged alternately along an extension direction of the connection pad; and
wherein a cross-sectional area of at least one of the first portions in a direction perpendicular to the extension direction of the connection pad is less than a cross-sectional area of at least one of the second portions in the direction perpendicular to the extension direction of the connection pad, and/or a melting point of at least one of the first portions is lower than a melting point of at least one of the second portions.

2. The to-be-cut display panel according to claim 1, wherein the cross-sectional area of at least one of the first portions in the direction perpendicular to the extension direction of the connection pad is less than the cross-sectional area of at least one of the second portions in the direction perpendicular to the extension direction of the connection pad, a width W11 of the at least one of the first portions is less than a width W12 of the at least one of the second portions, and both a width direction of the at least one of the first portions and a width direction of the at least one of the second portion are perpendicular to the extension direction of the connection pad.

3. The to-be-cut display panel according to claim 2, wherein a length L11 of the at least one of the first portions satisfies: L11≥3 μm, and a length direction of the first portion is parallel to the extension direction of the connection pad.

4. The to-be-cut display panel according to claim 2, wherein the width W11 of the at least one of the first portions satisfies: 3 μm≤W11≤5 μm.

5. The to-be-cut display panel according to claim 2, wherein a length L12 of the at least one of the second portions satisfies: L12<S−X−D1, wherein S represents a shortest distance between two adjacent drive pads, X represents a bonding accuracy of binding a chip on film (COF) to the drive pads, and D1 represents a diameter of a conducting particle, and wherein the conducting particle is configured to electrically connect the COF to the drive pads.

6. The to-be-cut display panel according to claim 2, wherein the width W12 of the at least one of the second portion satisfies: W12≥5.5 μm.

7. The to-be-cut display panel according to claim 2, wherein a shortest distance between two adjacent connection pads is greater than or equal to P1/2, and P1=W12+S1, where W12 represents the width of the at least one of the second portions, and S1 represents the shortest distance between the two adjacent connection pads.

8. The to-be-cut display panel according to claim 1, wherein a shape of an edge of the at least one of the first portions is an arc or a straight line.

9. A chip on film (COF), comprising: a plurality of pins, wherein at least one of the plurality of pins comprises a third portion and a fourth portion, a width of the third portion is less than a width of the fourth portion, both a width direction of the third portion and a width direction of the fourth portion are perpendicular to an extension direction of the at least one of the plurality of pins, and the third portion is adjacent to an edge of the COF.

10. The COF according to claim 9, wherein a shortest distance S21 between two adjacent third portions satisfies: S21≥(W21+S21)/2, where W21 represents the width of the third portion, S21 represents the shortest distance between the two adjacent third portions, and wherein the width direction of the third portion is perpendicular to the extension direction of the pins.

11. The COF according to claim 9, wherein the width of the fourth portion is less than or equal to a shortest distance between two adjacent fourth portions, and the width direction of the fourth portion is perpendicular to the extension direction of the pins.

12. The COF according to claim 9, wherein a length L21 of the third portion and a length L22 of the fourth portion satisfy: L22/10≤L21≤L22/6.

13. The COF according to claim 9, wherein a fifth portion is further provided between the third portion and the fourth portion, and an angle α is formed between an edge of the fifth portion and an edge of the third portion, wherein 120°≤α≤150°.

14. A display panel formed by cutting a to-be-cut display panel, wherein the to-be-cut display panel comprises:
a display region comprising:
sub-pixels; and
a non-display region comprising:
at least one drive pad electrically connected to the sub-pixels;
a test pad configured to receive a test signal and electrically connected to the at least one drive pad; and
a connection pad provided between the at least one drive pad and the test pad and configured to electrically connect the at least one drive pad to the test pad;
wherein the connection pad comprises a plurality of first portions and a plurality of second portions arranged alternately along an extension direction of the connection pad;
wherein a cross-sectional area of at least one of the first portions in a direction perpendicular to the extension direction of the connection pad is less than a cross-sectional area of at least one of the second portions in the direction perpendicular to the extension direction of the connection pad, and/or a melting point of at least one of the first portions is lower than a melting point of at least one of the second portions; an
wherein a cutting line passes through the connection pad.

15. The to-be-cut display panel according to claim 14, wherein the cross-sectional area of at least one of the first portions in the direction perpendicular to the extension direction of the connection pad is less than the cross-sectional area of at least one of the second portions in the direction perpendicular to the extension direction of the connection pad, a width W11 of the at least one of the first portions is less than a width W12 of the at least one of the second portions, and both a width direction of the at least one of the first portions and a width direction of the at least one of the second portion are perpendicular to the extension direction of the connection pad.

16. The to-be-cut display panel according to claim 15, wherein a length L11 of the at least one of the first portions satisfies: L11≥3 μm, and a length direction of the first portion is parallel to the extension direction of the connection pad.

17. The to-be-cut display panel according to claim 15, wherein the width W11 of the at least one of the first portions satisfies: 3 μm≤W11≤5 μm.

18. The to-be-cut display panel according to claim 15, wherein a length L12 of the at least one of the second portions satisfies: L12<S−X−D1, wherein S represents a shortest distance between two adjacent drive pads, X represents a bonding accuracy of binding a chip on film (COF) to the drive pads, and D1 represents a diameter of a conducting particle, and wherein the conducting particle is configured to electrically connect the COF to the drive pads.

19. The to-be-cut display panel according to claim 15, wherein the width W12 of the at least one of the second portion satisfies: W12≥5.5 μm.

20. The to-be-cut display panel according to claim 15, wherein a shortest distance between two adjacent connection pads is greater than or equal to P1/2, and P1=W12+S1, where W12 represents the width of the at least one of the second portions, and S1 represents the shortest distance between the two adjacent connection pads.
